(19) United States
(12) Patent Application Publication
(10) Pub. No.: US 2019/0212131 A1
(43) Pub. Date: Jul. 11, 2019

(54) PIPELINE DEPTH OF COVER DETERMINATION METHOD AND APPARATUS

(71) Applicant: Quanta Associates, L.P., Houston, TX (US)

(72) Inventors: Douglas W. Spencer, Rapid City, MI (US); Jabin D. Reinhold, Traverse City, MI (US)

(21) Appl. No.: 16/243,484

(22) Filed: Jan. 9, 2019

Related U.S. Application Data
(60) Provisional application No. 62/615,455, filed on Jan. 10, 2018.

(51) Int. Cl. G01B 11/22; G01C 11/00; G01S 19/45; G01S 17/89

(52) U.S. Cl. CPC G01B 11/22; G01S 17/89; G01S 19/45; G01C 11/00

(57) ABSTRACT

A method for determining depth of a conduit below a ground surface includes moving an inline tool along and within the conduit and collecting pipeline elevation data of the conduit. The method also includes placing a plurality of aircraft targets on the ground surface above the conduit and collecting, by an aircraft, surface data of the ground surface. The method includes receiving, at a controller, survey data of the ground surface. The method includes determining, based on the surface data and the survey data, an ellipsoidal height of the ground surface and determining a depth of cover of the conduit based on the ellipsoidal height and the pipeline elevation data.

### CROSS REFERENCE TO RELATED APPLICATION

The present application claims the filing benefits of U.S. provisional application Ser. No. 62/615,455, filed Jan. 10, 2018, which is hereby incorporated herein by reference in its entirety.

### BACKGROUND OF THE INVENTION

It is often necessary to determine the depth of cover of buried pipelines. The depth of cover of a buried pipeline is the vertical distance from the top of the pipe barrel to the surface.

### SUMMARY OF THE INVENTION

A method and apparatus to obtain superior accuracy in depth of cover of buried pipelines through the usage of any measurement combination of known survey points/locations, high precision surveys, an inline inspection (ILI) tool equipped with an inertial measurement unit (IMU), and an aircraft equipped with any single technology or combination of LIDAR, GPS, photogrammetric equipment, etc. The method utilizes ellipsoidal height measurements to determine surface elevation.

The method includes moving an inline tool along and within the conduit and collecting pipeline elevation data of the conduit. The method also includes placing a plurality of aircraft targets on the ground surface above the conduit and collecting, by an aircraft, surface data of the ground surface above the conduit. The method includes receiving, at a controller, survey data of the ground surface above the conduit. The method also includes determining, by a controller and based on the surface data and the survey data, an ellipsoidal height of the ground surface and determining, by the controller, a depth of cover of the conduit based on the ellipsoidal height and the pipeline elevation data.

These and other objects, advantages, purposes and features of the present invention will become apparent upon review of the following specification in conjunction with the drawings.

### BRIEF DESCRIPTION OF THE DRAWINGS

FIG. 1 is a schematic of a pipeline depth determining system in accordance with the present invention;

FIG. 2 is a schematic of another pipeline depth determining system in accordance with the present invention; and

FIG. 3 is a schematic of another pipeline depth determining system in accordance with the present invention.

### DESCRIPTION OF PREFERRED EMBODIMENTS

The present invention provides development of a process that identifies locations using a formal International Terrestrial Reference Frame (ITRF), rather than a typical local datum or national spatial reference system. This includes using the formal geophysical parameters that are defined for that ITRF and using the appropriate mathematics to create true geodetic surveys of the pipeline and of the surrounding terrain. There are two separate geodetic surveys. One uses LIDAR or orthophotography or any other method for determining surface elevations. The other uses an inertial measurement unit (IMU). Then, using the correct physical model and mathematics (e.g., earth-centered, earth-fixed (ECEF) instead of earth-centered inertial (ECI)), the actual depth differences may be determined.

The apparatus and method of the present invention includes an Inline Inspection (ILI) tool utilizing an Inertial Measurement Unit (IMU) and an aircraft (e.g., fixed, rotary wing, unmanned aerial vehicle (UAV), etc.) with LIDAR and/or cameras disposed thereat. Additionally, other LIDAR or photogrammetry equipment may be used. High precision surveying equipment along with Above Ground Markers (AGM) and/or aircraft targets (visual, electronic, magnetic, etc.) may also be used. The apparatus also includes analysis software and associated hardware for executing the analysis software (e.g., a controller with memory hardware).

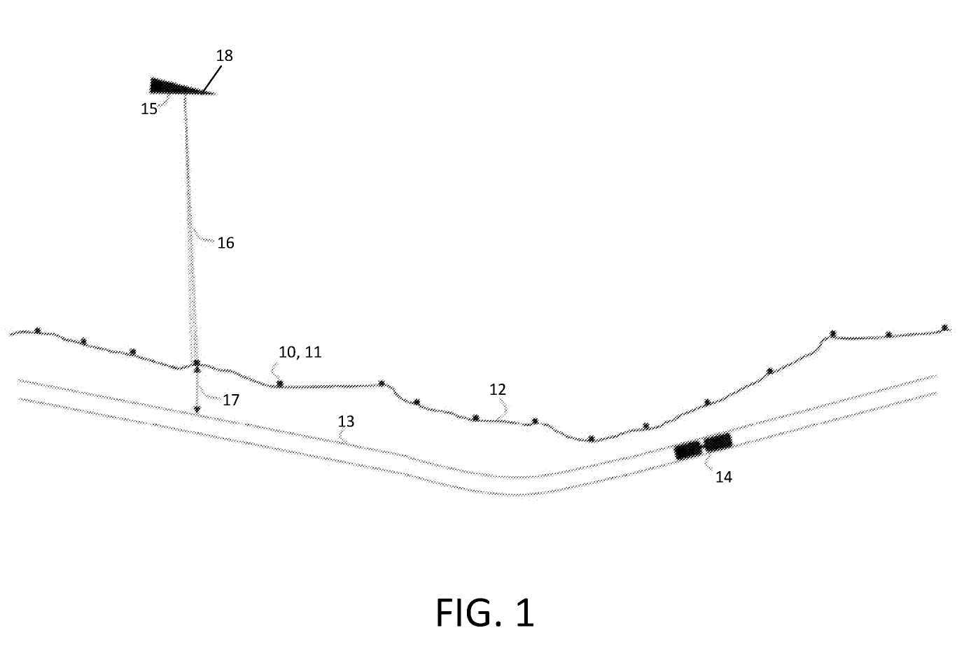

Referring now to FIG. 1, highly accurate surveys are performed utilizing high precision surveying equipment. These highly accurate surveys provide for an initial surface elevation and depth of cover data. These surveys may be performed, for example, by using multiple Global Navigation Satellite System (GNSS) sources, long static periods, or other augmentation to produce high absolute accuracy in the ITRF. The highly accurate surveys are performed with known locations along the pipeline that can be readily identified in a data stream from an ILI tool, or to AGM locations. That is, the survey data may be correlated to the known locations or to placed AGMs. When there are not known locations available, AGMs 10 may be placed on the ground surface 12 above the conduit or pipeline 13. An ILI tool 14 that includes an IMU travels through the pipeline 13. IMU data collected by the IMU in the ILI 14 as the ILI 14 travels through the pipeline 13 is mapped horizontally and vertically in space in order to collect pipeline elevation data. The pipeline elevation data represents ellipsoid height in the ITRF.

The data may be mapped either in real-time (i.e., as the ILI 14 travels through the pipeline 13) or post-run (i.e., after the ILI 14 has completed travelling through the pipeline 13). The data may be correlated with the placed AGMs 10 (i.e., the pipeline elevation data at each AGM 10 is recorded). The AGMs 10 may then be replaced with aircraft targets 11, or, optionally, the aircraft targets 11 are placed at the aforementioned known locations along the pipeline (i.e., when AGMs 10 are not used). It is understood that the AGMs 10 need not actually be replaced, and instead the aircraft targets 11 may instead be placed suitably close to the AGMs 10. An aircraft 15 (e.g., manned or unmanned such as a UAV) equipped with, for example, LIDAR, photogrammetric equipment, GPS, etc. (or any combination thereof) performs a flyover of the pipeline 13 following the defined aircraft targets 11 (or AGMs 10) placed at the known locations along the pipeline 13 and gathers data using the equipped hardware. For example, when the aircraft 15 is equipped with LIDAR, the aircraft 15 conducts a LIDAR scan 16 of the ground surface 12 guided by the aircraft targets 11. The aircraft targets 11 include any device or element that are readily sensed by the equipped hardware of the aircraft 15 (such as elements comprising a material that is readily sensed by a LIDAR sensing system or the like) so that the data gathered by the equipped hardware may be correlated with the data gathered by the ILI 14 (at the AGMs 10).

The aircraft 15 collects surface data using the equipped hardware (e.g., LIDAR, cameras, etc.). A controller 18 processes and resolves the collected surface data with the previously surveyed locations via analysis software. The controller 18 may process the data in real-time as the aircraft 15 collects it, or may process the data post-flight. While in the illustrated example, the controller 18 is located on the aircraft 15, the controller 18 may be located remote from the aircraft 15 (e.g., at the ground surface or at a remote facility). The surface data may be processed on the aircraft 15 during or after flight, wirelessly transmitted off the aircraft 15 during or after flight, or collected from the aircraft 15 after completion of flight. In some examples, acquired imagery is evaluated through computer vision and structure from motion methods.

The controller 18, receives the survey data (i.e., the initial surface elevation and depth of cover information) and the surface data from the aircraft 15, and determines an ellipsoidal height using the previously stated data acquisition and analysis. The controller 18 also receives the pipeline elevation information from the IMU of the ILI 14. The controller 18 subtracts the pipeline elevation data from corresponding ellipsoid height (i.e., surface elevation) obtained from the previous processing, which results in the depth of cover. Thus, the depth of cover is equal to

e−p=d (1)

Here, e is the surface elevation (i.e., ellipsoid height), p is the pipeline elevation, and d is the resulting depth of cover.

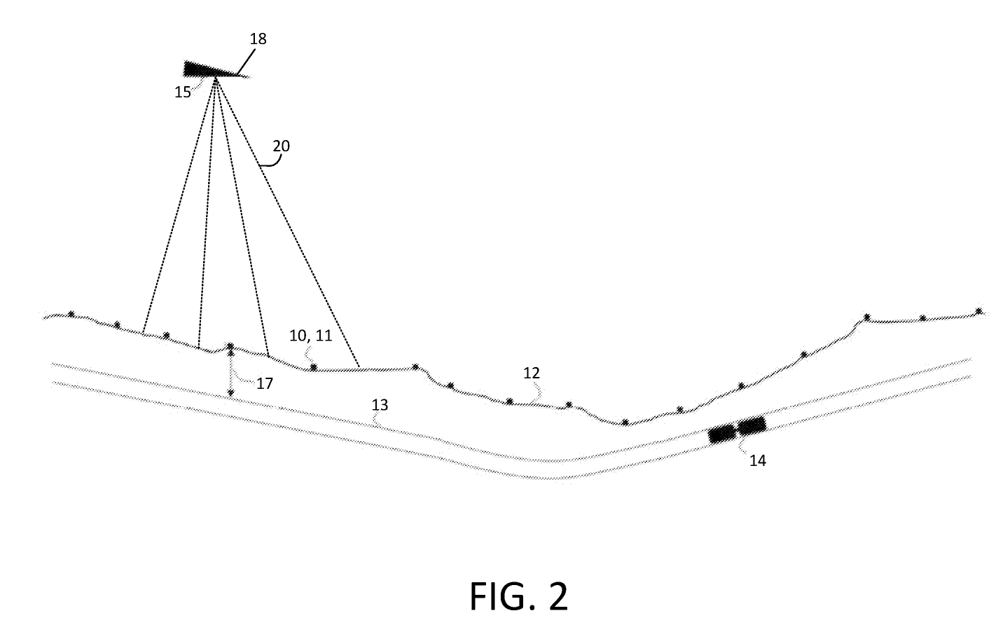

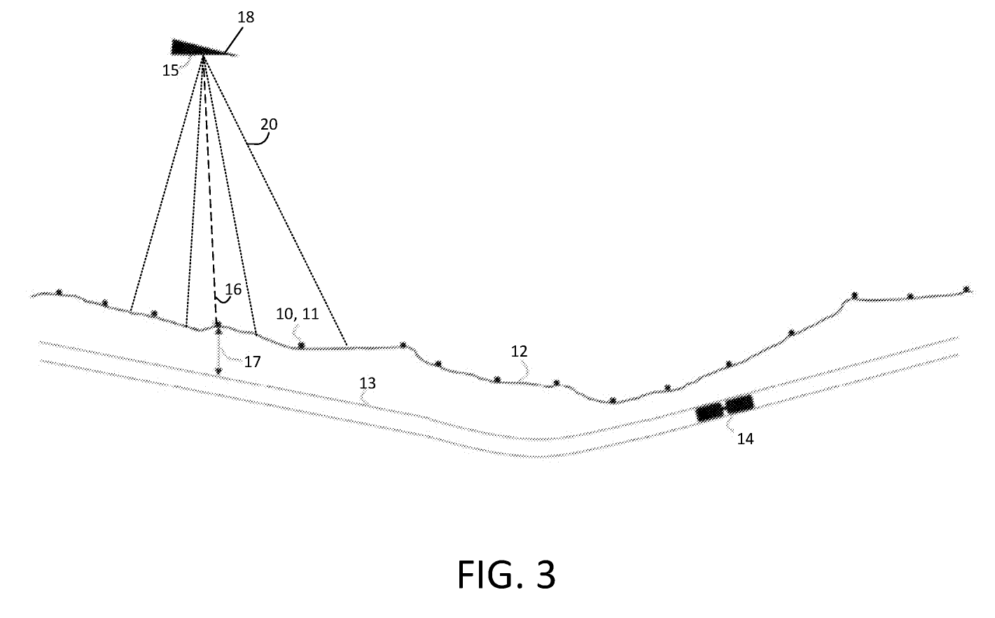

As shown in FIGS. 1-3, the aircraft 15 may use any sort of technology to obtain the surface data necessary to determine the ellipsoid height. For example, in addition to LIDAR (FIG. 1), the aircraft 15 may use GPS and cameras (FIG. 2). For example, the aircraft 15 may use a camera to take photographs 20 for photogrammetry. As illustrated in FIG. 3, a combination of GPS, LIDAR, and cameras may be used. FIGS. 1-3 show varying system and aircraft configurations, and are not restrictive of technologies or configurations used in accordance with the present invention.

Therefore, the present invention provides a system that that determines depth of a conduit below a ground surface, with the system collecting pipeline elevation data of the conduit via an inline tool that moves along the conduit. A plurality of aircraft targets are placed on the ground surface above the conduit, whereby an aircraft can fly over and along the conduit and collect surface data based on the plurality of aircraft targets. A controller receives the survey data of the ground surface above the conduit and determines (via processing of collected data), an ellipsoidal height of the ground surface above the conduit based at least in part on the surface data collected by the aircraft and the survey data. The controller then can determine a depth of cover of the conduit based on the determined ellipsoidal height and the pipeline elevation data.

Changes and modifications to the specifically described embodiments may be carried out without departing from the principles of the present invention, which is intended to be limited only by the scope of the appended claims as interpreted according to the principles of patent law including the doctrine of equivalents.

1. A method that determines depth of a conduit below a ground surface, said method comprising:
moving an inline tool along and within the conduit;
collecting, by the inline tool, pipeline elevation data of the conduit as the inline tool moves along the conduit;
placing a plurality of targets at the ground surface along the conduit;
detecting, via a sensor at an aircraft, the targets as the aircraft travels over the targets;
collecting, by the sensor at the aircraft, surface data based on the detected plurality of targets;
receiving, at a controller, survey data of the ground surface above the conduit;
determining, by the controller, an ellipsoidal height of the ground surface above the conduit based at least in part on (i) the surface data collected by the aircraft and (ii) the survey data; and
determining, by the controller, a depth of cover of the conduit based at least in part on (i) the determined ellipsoidal height and (ii) the collected pipeline elevation data.

2. The method of claim 1, wherein the inline tool comprises an inertial measurement unit (IMU).

3. The method of claim 1, further comprising placing above ground markers (AGMs) at the ground surface along the conduit;
wherein the inline tool collects pipeline elevation data when below an AGM; and
wherein the plurality of targets are placed at the same locations as the placed AGMs.

4. The method of claim 3, wherein the AGMs are placed at locations that correspond with the survey data.

5. The method of claim 4, comprising correlating, by the controller, the survey data with the pipeline elevation data and the surface data at the location of each AGM.

6. The method of claim 1, wherein the aircraft comprises a LIDAR sensor, and wherein the aircraft collects surface data via the LIDAR sensor.

7. The method of claim 1, wherein the aircraft comprises a global positioning system (GPS) sensor and a camera, and wherein the aircraft collects surface data via the GPS sensor and the camera.

8. The method of claim 1, wherein the aircraft comprises a LIDAR sensor, a global positioning system (GPS) sensor, and a camera, and wherein the aircraft collects surface data via the LIDAR sensor, the GPS sensor, and the camera.

9. The method of claim 1, wherein determining the depth of cover comprises subtracting the pipeline elevation data from the corresponding ellipsoidal height.

10. The method of claim 1, wherein determining the ellipsoidal height comprises processing the surface data with at least one of (i) computer vision methods or (ii) structure from motion methods.

11. The method of claim 1, wherein collecting the pipeline elevation data comprises mapping space horizontally and vertically from the inline tool.

12. A system that determines depth of a conduit below a ground surface, said system comprising:
an inline tool disposed within the conduit, wherein the inline tool moves along and within the conduit and collects pipeline elevation data of the conduit as the inline tool moves along the conduit;
a plurality of targets disposed at the ground surface along the conduit;
an aircraft, wherein the aircraft comprises a sensor, and wherein the sensor detects the targets as the aircraft travels over the targets, and wherein the sensor collects surface data based on the detected plurality of targets;
a controller, wherein the controller receives survey data of the ground surface above the conduit, and wherein the controller determines an ellipsoidal height of the ground surface above the conduit based at least in part on (i) the surface data collected by the aircraft and (ii) the survey data; and
wherein the controller determines a depth of cover of the conduit based at least in part on (i) the determined ellipsoidal height and (ii) the collected pipeline elevation data.

13. The system of claim 12, wherein the inline tool comprises an inertial measurement unit (IMU).

14. The system of claim 12, further comprising above ground markers (AGMs) placed at the ground surface along the conduit;
wherein the inline tool collects pipeline elevation data when below an AGM; and
wherein the plurality of targets are placed at the same locations as the placed AGMs.

15. The system of claim 14, wherein the AGMs are placed at locations that correspond with the survey data.

16. The system of claim 15, wherein the controller correlates the survey data with the pipeline elevation data and the surface data at the location of each AGM.

17. The system of claim 12, wherein the aircraft comprises a LIDAR sensor, and wherein the aircraft collects surface data via the LIDAR sensor.

18. The system of claim 12, wherein the aircraft comprises a global positioning system (GPS) sensor and a camera, and wherein the aircraft collects surface data via the GPS sensor and the camera.

19. The system of claim 12, wherein the aircraft comprises a LIDAR sensor, a global positioning system (GPS) sensor, and a camera, and wherein the aircraft collects surface data via the LIDAR sensor, the GPS sensor, and the camera.

20. The system of claim 12, wherein the controller determines the depth of cover by subtracting the pipeline elevation data from the corresponding ellipsoidal height.

21. The system of claim 12, wherein the controller determines the ellipsoidal height by processing the surface data with at least one of (i) computer vision methods or (ii) structure from motion methods.

22. The system of claim 12, wherein the inline tool collects the pipeline elevation data by mapping space horizontally and vertically from the inline tool.
